(19) United States
(12) Patent Application Publication
(10) Pub. No.: US 2015/0154324 A1
(43) Pub. Date: Jun. 4, 2015

(54) METHOD IN THE MANAGEMENT OF DATA RELATING TO AN ELEVATOR

(71) Applicant: KONE Corporation, Helsinki (FI)

(72) Inventors: Esa REILIO, Helsinki (FI); Hannu KULJU, Hyvinkaa (FI); Markku HAAPANIEMI, Helsinki (FI); Matti RÄSÄNEN, Hyvinkaa (FI); Otto KORKALO, Helsinki (FI); Simo MÄNTYNEN, Hyvinkaa (FI)

(73) Assignee: KONE Corporation, Helsinki (FI)

(21) Appl. No.: 14/621,138

(22) Filed: Feb. 12, 2015

Related U.S. Application Data
(63) Continuation of application No. PCT/FI2013/050799, filed on Aug. 14, 2013.

(30) Foreign Application Priority Data
Aug. 17, 2012 (FI) 20125858

(51) Int. Cl. G06F 17/50; B66B 5/00

(52) U.S. Cl. CPC G06F 17/5004; B66B 5/0087

(57) ABSTRACT

A method in the management of data relating to an elevator structure is provided. Data is collected about the structures of the elevator, and the collected data is recorded in memory. In the method, the structures of an elevator are scanned with scanning apparatus, which collects scanning data relating to the shape of the structures being scanned, the scanning data is recorded in memory, and a three-dimensional model of the aforementioned structures of the elevator is formed on the basis of the scanning data.

### FIELD OF INVENTION

The object of the invention is a method in the management of the data of one or more elevators, more particularly in the management of data relating to an elevator structure, which elevator is preferably an elevator applicable to passenger transport and/or freight transport.

### BACKGROUND OF THE INVENTION

A problem in prior-art methods in the management of elevator data has been the inaccuracy of the data possessed about the elevators and at times the occurrence of structures diverging to what the available data indicates. The data relating to individual elevators is either collected on site or the data is based on information about what type of elevator or what type of components were delivered to the installation site at the time. The data can also be stored in an electronic database or in another type of archive.

Data relating to an individual elevator often contains information about its properties, such as about the structures of parts installed earlier as a part of the elevator. This type of data can be needed in many different situations, such as e.g. in connection with servicing, when planning a modernization or in connection with an initial installation.

In manufacturing, the structures of an elevator are generally positioned in relation to each other according to a plan made earlier. Often the elevator structures installed earlier during the installation process are assumed in later stages to be according to what is planned. A problem has been that the positioning of individual structures does not always fully correspond to the plan. Clear deviations from the plan are simple to detect visually or with possible verifying measurements, but smaller deviations easily remain unnoticed. Also, verifying measurements are not always thorough enough, but instead are spot checks in nature. Measurements are also performed by manually measuring. What has hindered the installation process is that the deviations from the plan undetected during it might only be noticed when problems caused by them arise, e.g. when a component intended for later installation does not fit into position when being installed. It would be advantageous to detect deviations as soon as possible in time, in which case rectification of them can be started in time or later stages can be dimensioned to take a deviation into account. For example, problems might arise if the shape of the elevator hoistway does not fully correspond to the plan or is otherwise not of the type of the prevailing assumption. For example, in the case of an elevator to be installed in a new building still under construction, the elevator hoistway can be finished in the builder's casting to be deviating slightly from the vertical or to be vertical but to curl slight at its top end. In this case problems can occur in later component placements or the travel clearances of the elevator can remain smaller than what is intended. Corresponding problems have been caused if the positions of the door openings of floor landings leading out from the hoistway are not quite aligned in the vertical direction. The types of problems described above have also been caused in cases in which the elevator is installed into a completed building, but also in connection with elevator modernization. For example, problems have been caused if a new elevator is installed in the elevator hoistway of an old elevator and the data about the elevator hoistway of the old elevator are defective or deficient. For example, the end of the beam of a building can remain unnoticed in verifying measurements. Even if the extra structure were small in size, its removal without risking the strength of the building can be awkward. This kind of detection only when installing new elevator components causes delay or requires modification of the layout of the elevator being installed and the ordering of new parts to the installation worksite.

In general, the deficiency of information relating to individual elevators and uncertainty as to the validity of the data has caused problems. Taking the preceding into account, a need has arisen for a more developed method in the management of elevator data. More particularly, there would be a need to know more accurately than before the actual location of elevator structures for later procedures to be carried out to the elevator.

### BRIEF DESCRIPTION OF THE INVENTION

The aim of the present invention is to solve the aforementioned problems of prior-art solutions as well as the problems disclosed in the description of the invention below. One aim, among others, is to produce a method by means of which it is known more reliably than before what kinds the structures of an individual elevator are. Embodiments are disclosed here with which, inter alia, the data of a number of elevators can be managed, knowing reliably what kinds the structures of each individual elevator are, in which case reliable data can be efficiently obtained about any desired elevator whatsoever for any purpose of use whatsoever.

In the method according to the invention in the management of data relating to an elevator, data is collected about the structures of the elevator, and the collected data is recorded in memory. In the method these phases are performed:
the structures of an elevator are scanned with scanning apparatus, which collects scanning data relating to the shape of the structures being scanned, and
the scanning data is recorded in memory, and
a three-dimensional model of the aforementioned structures of the elevator is formed on the basis of the scanning data.

In this way realistic data about the structures of an elevator can be achieved. The actual shape and/or actual position of the elevator structures can in this way be ascertained more accurately than before for later procedures, such as for installations, modernization, servicing or for another purpose, to be performed on the elevator. In this way the number of measuring errors or other deficiencies, inter alia, is smaller than before. Likewise the available data about an elevator is more comprehensive than before.

In one preferred embodiment the structures of an elevator are scanned with a scanning apparatus at the elevator site, i.e. at the site in which an elevator is situated or in which an elevator or its structures are being installed. In this way data relating to an elevator site, e.g. about structures already installed, can be acquired.

In one preferred embodiment the structures of an elevator are scanned with a scanning apparatus inside a space of the elevator. In this way data e.g. about structures already installed in the space, or about the shape of the space itself, can be acquired.

In one preferred embodiment the structures of an elevator are scanned with a scanning apparatus while moving the scanning apparatus during the scanning. In this way scanning can be simply and efficiently performed in the case of large objects with a small number of receivers.

In one preferred embodiment the structures of an elevator are scanned with a scanning apparatus while moving the scanning apparatus during the scanning inside a space of the elevator, and the structures being scanned comprise the structures bounding the space in question and/or the structures that are inside the space in question. In this way reliable data about the structures of an elevator, said data covering large surface areas, can be simply and efficiently collected.

In one preferred embodiment the aforementioned space is one or more of the following: an elevator hoistway, a machine room, an interior of an elevator car. In this way the shape of the aforementioned one or more spaces can be reliably ascertained for later use of the data.

In one preferred embodiment the scanning apparatus is 3D scanning apparatus, preferably comprising a plurality of cameras at a distance from each other.

In one preferred embodiment the scanning apparatus is 3D scanning apparatus utilizing structured light. For this purpose the scanning apparatus can comprise a device, such as a projector, sending structured light to the structure being scanned. In this way it is simple in badly illuminated conditions, such as in an elevator hoistway, to reliably achieve a reliable scanning result.

In one preferred embodiment in the scanning phase the structures being scanned comprise the structures bounding a space of an elevator, including one or more of the following:
the wall(s) of the space,
the ceiling/roof of the space,
the floor of the space.

The formation of a three-dimensional model from one or more of these enables simplification of a number of later phases and better reliability of the data possessed. Explicit clarification of the prevailing shape of structures can take place later simply and quickly by means of a three-dimensional model without going to visit the site.

In one preferred embodiment in the scanning phase the structures being scanned comprise the edges of the opening/openings of floor landings.

In one preferred embodiment in the scanning phase the structures being scanned comprise the structures inside a space of an elevator, including one or more of the following:
a guide rail/guide rails of the elevator, such as the guide rail/guide rails of the elevator car and/or counterweight,
the device(s) of the elevator that is/are inside the space, or parts of said device(s), such as an overspeed governor, an elevator control unit, a hoisting machine or parts thereof.
the rope(s) of the elevator that is/are inside the space.

In this way the dominant shape of the structures can be taken into account in the future. In this way explicit clarification of the data of structures can take place later simply and quickly by means of a three-dimensional model without going to visit the site.

In one preferred embodiment in the scanning a series of collection phases of scanning data to be linked to the shape of a structure being scanned is performed. Preferably the elevator structures are scanned with a scanning apparatus while moving the scanning apparatus during the scanning and the series comprises the data collection phases in different scanning positions. Preferably each data collection phase comprises the receiving of one, two or more images of the same point of the structure being scanned. In this case preferably each data collection phase comprises the receiving of two or more images of the same point of the structure from different directions with one, two or more receivers (e.g. with a camera).

In one preferred embodiment during the scanning the position data of the scanning apparatus is collected, more particularly the position data of the receiver comprised in the scanning apparatus. Preferably before performing the scanning a reference point is defined, in relation to which the position data collected during the scanning is defined. Preferably the position data of the scanning apparatus is collected by means of the signal of an acceleration sensor and/or before scanning a laser beam is placed to indicate the movement direction of the scanning apparatus and the position data of the scanning apparatus in relation to the laser beam is collected.

In one preferred embodiment in each collection phase collecting position data is connected to the collected data, which collecting position data preferably comprises the prevailing position data of the scanning apparatus (more particularly the position data of the receiver collecting data). In this way the scanning data collected from the different positions can be situated in relation to each other for forming a larger entity from the parts.

In one preferred embodiment in each collection phase time data is connected to the collected data, which time data indicates the collecting moment of the data, such as e.g. the moment when each image was taken. This can be used for determining the position information of the scanning data collected from different positions.

In one preferred embodiment the aforementioned three-dimensional model is linked to form at least a part of the data that is in the database and is linked to the elevator-identification of the elevator in question, which database comprises a plurality of elevator-identifications and the data of an identified elevator connected to each elevator-identification. In this way a database can be formed, from which can be brought forth accurate and reliable data of the desired elevator on the basis of its identification and a structure of it can be inspected without going to the site. This efficiently supports the servicing process or the planning of modernization.

In one preferred embodiment in the method a computer program is executed, which program forms a three-dimensional model on the basis of scanning data. In one preferred embodiment the aforementioned three-dimensional model is formed to be presentable to the user visually by means of a computer (preferably on a computer display). The aforementioned three-dimensional model can preferably be presented in this way with a CAD program. The aforementioned three-dimensional model is preferably recorded in memory in digital format.

In one preferred embodiment in the method a program is executed, which is arranged to identify the structures of an elevator, more particularly elevator devices such as e.g. an overspeed governor, motor or other electronic device, from the scanning data or from a three-dimensional model formed on the basis of the scanning data, by comparing the scanning data to the data of known structures contained in a structure database, e.g. a device database.

In one preferred embodiment the scanning apparatus is moved in the scanning phase in the space of the elevator, along with the elevator car or counterweight.

In one preferred embodiment the elevator is an elevator that is in use or has been in use. In this way data is collected from this type of elevator for later procedures, such as for servicing or modernization.

In one preferred embodiment the elevator is an elevator under construction to be installed for the first time (an elevator to be installed in a space that has no elevator).

In one preferred embodiment the structures being scanned comprise the structures bounding a space of an elevator and/or the structures that are inside a space of an elevator, and after the formation of the aforementioned three-dimensional model the elevator structures are installed into the aforementioned space. In this way a three-dimensional model can function as a part of the design process, enabling the selection or adaptation of later structures on the basis of the real elevator structure. In this way e.g. space usage can be made more efficient. The elevator can in this case be e.g. an elevator under construction being installed for the first time, or an old elevator that is modernized or serviced.

In one preferred embodiment after the formation of a three-dimensional model the scanned structure is modified. For example, in this case a structure bounding an elevator space scanned in the scanning phase, of which structure a three-dimensional model has earlier been formed, and/or the elevator structures (such as parts or devices) that is/are inside the elevator space scanned in the scanning phase, of which structures a three-dimensional model has earlier been formed, is/are modified. In this way deficiencies in earlier installations, e.g. a faulty casting of the elevator hoistway, can be noticed in time.

In one preferred embodiment the structures being scanned comprise the structures bounding a space of the elevator and/or the structures that are inside a space of an elevator, and after the formation of the aforementioned three-dimensional model the elevator structures are installed into the aforementioned space, which structures preferably comprise one or more of the following:
an elevator car,
the device(s) of the elevator, or parts of said devices, such as an overspeed governor, an elevator control unit, a hoisting machine or parts thereof,
a guide rail/guide rails of the elevator, such as the guide rail/guide rails of the elevator car and/or counterweight,
the rope(s) of the elevator, such as suspension ropes.

In one preferred embodiment from the scanning data or from a three-dimensional model formed on the basis of the scanning data, the distance of the elevator ropes from each other is determined, more particularly the horizontal distance from each other of ropes traveling essentially vertically downwards from the traction sheave on different sides in the hoistway.

Preferably the scanning data relating to the shape of structures being scanned comprises data about the shape and the dimensions of the structure being scanned. In this way a three-dimensional model can be formed to be of corresponding shape to the scanned structure and its exact dimensions are known, in which case the three-dimensional can be combined with other three-dimensional models, e.g. for determining the compatibility (e.g. from the viewpoint of space usage) of the structures described by them. Exact dimension data could, however, be determined otherwise also, such as e.g. by means of reference measurements.

The elevator is most preferably a type of elevator applicable to the transporting of people and/or of freight, which elevator is installed in a building, to travel in a vertical direction, or at least in an essentially vertical direction, preferably on the basis of landing calls and/or car calls. The elevator car preferably has an interior space, which is suited to receive a passenger or a number of passengers. The elevator preferably comprises at least two, possibly more, floor landings to be served. Some inventive embodiments are also presented in the descriptive section and in the drawings of the present application. The elevator can be one with a machine room or one without a machine room. The elevator can be one with a counterweight or one without a counterweight. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments of the invention can be applied within the framework of the basic inventive concept in conjunction with other embodiments.

### BRIEF DESCRIPTION OF THE FIGURES

The invention will now be described mainly in connection with its preferred embodiments, with reference to the attached drawings, wherein

FIG. 1 presents a preferred arrangement, with which the scanning phase of the method can be performed.

FIG. 2 presents one preferred receiver configuration of the scanning apparatus, as viewed from above.

### DETAILED DESCRIPTION OF THE INVENTION

In one preferred embodiment of the invention in the management of data relating to an elevator structure, data is collected about the structures of an elevator, and the collected data is recorded in memory. In the method the structures (i.e. one or more structures) of an elevator are scanned with scanning apparatus, which collects scanning data relating to the shape of the structures being scanned. The scanning data is recorded in memory, e.g. in digital memory. A three-dimensional model of the aforementioned elevator structures is formed on the basis of the collected scanning data. It is advantageous to convey with a memory, or to send scanning data for the formation of a three-dimensional model, from the location at which the scanning is performed to the system performing the three-dimensional model, e.g. to a computer that is remote from the scanning location. It is, however, also possible to form a three-dimensional model immediately on site with means integrated into the scanning apparatus itself or with apparatus in the proximity of the scanning apparatus, in which case the means preferably comprise a computer.

The elevator structures being scanned comprise either fully fabricated or partly fabricated elevator structures. A three-dimensional model offers real and reliable data about the shape of structures, which data can be reliably utilized for determining the later placement or modification need of the structure in question. Likewise, the needs relating to placement or modification of structures to be installed in the future in the proximity of a scanned structure can be determined in advance on the basis of the model. On the other hand, the information about a structure can also be used for any elevator use whatsoever or for a need related to servicing.

In one embodiment applying to the initial installation of an elevator the formation of a three-dimensional model in the aforementioned manner is a part of the fabrication of a new elevator in a space without an elevator, e.g. in a new building that is being constructed or in an old building that has no elevator and in which an elevator is being installed for the first time. A three-dimensional model can be utilized as an aid to installation in the middle of the installation work for the elevator by comparing a three-dimensional model formed from installed or fabricated elevator structures can be compared to the designed elevator, in which case a conception can be formed of whether the realized structure is according to plan. If the implemented structure does not sufficiently correspond to the designed structure, the structure is modified. For example, in this way the straightness or the dimensions of the walls of an elevator hoistway can be inspected, and the elevator hoistway can be modified if the need so requires. Alternatively, on the basis of a three-dimensional model, the plan of an elevator being fabricated can be modified or adapted in respect of other structures, such as components to be installed/fabricated later. After the formation of a three-dimensional model of the structures, the other elevator structures can also consequently be installed as a part of the elevator, e.g. into a space scanned during the scanning, taking into account the data offered by the three-dimensional model. For example, the dimensions/model of an elevator car can be configured in the manufacture of the elevator car to be optimal on the basis of the three-dimensional model formed of the elevator hoistway. In this way an elevator car possessing the maximum size for the hoistway can be selected and the hoistway space will be efficiently utilized. A three-dimensional model created by means of the method is not necessarily actually useful during the installation, but instead the data collected during the installation can be used also only later for any purpose whatsoever.

In one embodiment applying to modernization the formation of a three-dimensional model in the manner described earlier is a part of the modernization of an old elevator, in which the old elevator is at least partly replaced with a new one. In connection with modernization, for example, a three-dimensional model of the structures of an old elevator can be formed. For example, a three-dimensional model of the old elevator hoistway and/or of the components in it can be formed with the method. In this way the modification need of the structure in question can be determined or, on the basis of the three-dimensional model, the plan of an elevator being fabricated can be modified or adapted in respect of other structures, such as in respect of components to be installed/fabricated later, correspondingly to what is described above.

In one embodiment applying to the collection of general information the formation of a three-dimensional model in the aforementioned manner is a part of the collection of data about an existing elevator, e.g. for updating the database. In this case additional data about the existing elevator can be collected in the database without immediate utilization of the three-dimensional model. In this case the model can be utilized only when the need arises, e.g. in connection with servicing or in connection with determining modernization options, and possibly only later in implementing the modernization in ways corresponding to those described above. A model of the interior of an elevator car can also be utilized for determining the size of the interior of an elevator car for a customer, e.g. for determining capacity or accurate loadability dimensions. Any three-dimensional model whatsoever of an elevator structure can be used for the advance planning of servicing procedures (e.g. selection beforehand of tools, selection of a passageway or some other serviceman preview of the elevator structure in question). A three-dimensional model formed during modernization or installation can also be used for any of these purposes.

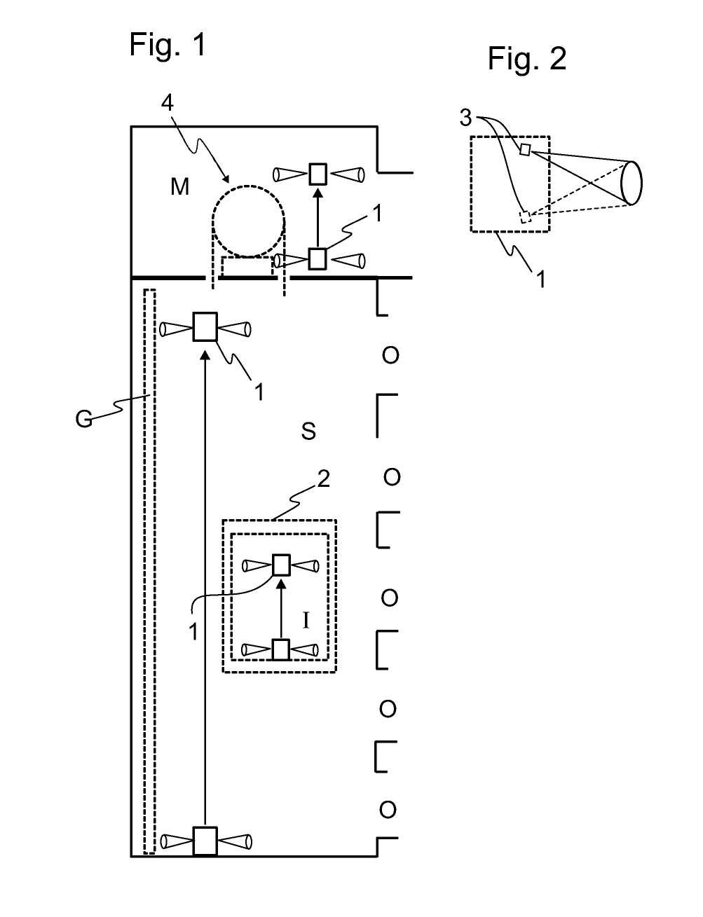

In each of the aforementioned embodiments the scanning can be implemented in principle in a corresponding manner, e.g. in the manner presented in FIG. 1. When the objects being scanned are structures that are already installed, the structures are scanned with scanning apparatus at the elevator site. Structures that are not yet installed can be scanned in any suitable place whatsoever, such as at the factory or at the elevator site. Installed structures are considered here to be, for example, the shapes, i.e. walls, ceiling and floor, bounding the interior of the elevator hoistway and of the machine room that can be scanned at the installation site, i.e. in the final disposal location of the elevator. Likewise, the openings O, or corresponding, of floor landings leading out of the hoistway are deemed to be installed structures. Likewise, the guide rails or other elevator components installed in the elevator hoistway or in the machine room, including also the elevator car if it is already in the hoistway, can be installed structures.

Preferably the structures of an elevator are scanned with a scanning apparatus inside a space of the elevator. FIG. 1 presents a scanning arrangement, which can be utilized in any of the aforementioned embodiments whatsoever in the manner described above. The space being scanned can according to FIG. 1, be an elevator hoistway S, a machine room M or the interior I of an elevator car. It is possible that a three-dimensional model is formed of some of these or of all of these.

In the case of all the different embodiments, the scanning of the elevator car 2 can take place at the elevator site, but this is not necessary. Namely, when the scanning is a part of a modernization or of the installation of a new elevator, generally a new elevator car 2 is fabricated, and in this case it would be possible to perform the scanning occurring in the inside space I of the elevator car 2 simply when the elevator car 2 is elsewhere than in the elevator hoistway S, e.g. already at the factory. When it is a question of the collection of data about an existing elevator, the scanning of the interior of the elevator car 2 can take place in the manner described in the figure at the elevator site.

In any embodiment whatsoever in the scanning phase the structures being scanned preferably comprise the structures bounding a space of an elevator, including e.g. the wall(s) of the space S, M, I, the ceiling/roof of the space and the floor of the space. In addition, or alternatively, in the scanning phase the structures being scanned comprise the structures inside a space S, M, I of an elevator, preferably including e.g. some of the following: guide rails G of the elevator, such as the guide rail/guide rails of the elevator car 2 and/or counterweight, devices of the elevator that are inside the space, such as an overspeed governor, an elevator control unit, a hoisting machine 4 or parts thereof, diverting pulleys, or elevator ropes that are inside the space. The structures being scanned can also comprise the shape of the elevator car 2 as it is observed from outside. With the exception of the guide rails G, the structures are not presented in FIG. 1 for the sake of clarity. Structures can be scanned accord to how they happen to be in the space being scanned at the time of the scanning phase.

In an embodiment applying to initial installation or modernization after the formation of a three-dimensional model, elevator structures can be installed in any aforementioned space of the elevator whatsoever. In this case on the basis of the data offered by a three-dimensional model, it is possible to select the optimal, or to dimension optimally, the additional structures to be installed, e.g. from the viewpoint of space efficiency or safety. The aforementioned additional structures can preferably comprise one or more of the following:
an elevator car 2,
elevator guide rails G, such as guide rails of an elevator car and/or counterweight
devices of the elevator or the parts of the devices, such as an overspeed governor, an elevator control unit, a hoisting machine 4 or parts thereof,
the rope(s) of the elevator, such as suspension ropes.

In any of the aforementioned three embodiments whatsoever it is advantageous to link the aforementioned the three-dimensional model(s) of the structure(s) to form at least a part of the data that is in the database and is linked to the elevator-identification of the elevator in question, which database comprises a plurality of elevator-identifications and the data of an identified elevator connected to each elevator-identification. The elevator database is, in practice, preferably an elevator database managed by the elevator manufacturer or by a customer responsible for an elevator plurality. The database can be situated e.g. in a central computer. Identification of an elevator can, in practice, be implemented e.g. by naming the elevator or by giving it an address. A three-dimensional model can be brought out of the database on the basis of its identification, in which case an elevator structure can be inspected very precisely according to need.

As a part of the method (e.g. when later processing collected and recorded data) a program can be executed, which is arranged to identify the structures of an elevator, more particularly elevator devices such as e.g. an overspeed governor, motor or other electronic device, directly from the scanning data or from a three-dimensional model formed on the basis of the scanning data, by comparing the scanning data to the data of known structures contained in a structure database, more particularly a database containing device-specific data. In this way the type or mark of a device at a site can, e.g. with an image recognition program, be determined. In this way sufficient data about elevator components can be collected for later needs, so that in later upcoming modernizations or servicing the devices at the site are known in great detail. It is advantageous to record this data in the aforementioned database linked to the identification identifying the elevator in question. Also photographs of the elevator in question can be recorded in the database, alongside a three-dimensional model, during the actual scanning or even as a part of the recorded photographs belonging to the scanning itself, if a scanning apparatus utilizing photography technology is used for the scanning.

It is advantageous to perform the scanning phase by moving the scanning apparatus 1 during the scanning inside the space S, M, I of the elevator, in which case the structures being scanned preferably comprise the structures bounding the space in question and/or the structures that are inside the space in question. As presented in FIG. 1, the scanning apparatus 1 can be moved in a space of the elevator linearly, at least in one direction, but movements in other directions are also possible. On the other hand, the moving is not necessary, if the scanning apparatus makes this possible. Preferably the scanning apparatus 1 is moved in at least the vertical direction of the space, preferably for at least most of the vertical height, in which case the structure of the space S,M,I will be scanned to a large extent in the vertical direction of the elevator for the three-dimensional model.

Preferably in the scanning a series of data collection phases to be linked to the shape of a structure being scanned is performed. The structures of an elevator are scanned with a scanning apparatus 1 while moving the scanning apparatus 1 during the scanning and the aforementioned series of data collection phases comprises data collection phases with the same apparatus, which is in different scanning positions in different scanning phases. In this way the scanning apparatus 1 can move while scanning large structures that cannot be scanned from one position. The structure being scanned preferably remains stationary during the whole of the scanning phase of the structure in question. Each data collection phase comprises the recording of one, two or more images or corresponding collected data from each point of the structure being scanned. The data collection density of a series can be sparse or dense, in which case in practice the collection of data is continuous during the scanning.

The movement of a moving scanning apparatus can differ to what is intended, so it is advantageous that during the scanning the position data of the scanning apparatus 1 is collected, more particularly the position data of the receiver/receivers 3 that collect(s) the data and is/are comprised in the scanning apparatus 1. In each collection phase collecting position data is preferably connected to the collected data, which data preferably comprises the prevailing position data of the scanning apparatus (position data of the receiver collecting data). On the basis of the collecting position data a three-dimensional model can be created simply, because in this way the points at which the different recordings are made are known. In this way recordings achieved with a number of data collections can be situated in relation to each other in a position corresponding to the actual structure and an integral scanning result for a large area from a series of interconnected scans that apply to small areas.

According to one implementation method the position data of the scanning apparatus 1 is collected during scanning by means of an acceleration sensor that is in connection with the scanning apparatus 1, and therefore moves along with the scanning apparatus, by using the signal produced by it for determining the position. Before performing the scanning a reference point is defined, in relation to which the position data collected during the scanning is defined. The position data can comprise coordinate data (x=length, y=width, z=height), which per se reveals for each specific data collection phase the prevailing position of the scanning apparatus in the coordinate system in each data collection phase, i.e. coordinate data, from which this type of position can later be ascertained by processing. The recording of position data can be done in the memory comprised in the scanning apparatus 1.

According to one implementation method for facilitating determination of the position data of the scanning apparatus 1, before the scanning a laser beam is placed to indicate the movement direction of the scanning apparatus 1. In this case the position of the scanning device can be determined in relation to the laser beam. Since the scanning of the scanning apparatus 1 collects at different moments the precise lateral position of the scanning apparatus in relation to the laser beam (e.g. with a receiver detecting the laser beam, said receiver moving along with the scanning apparatus), coordinate data corresponding to that described above can be determined in a corresponding manner to that described above. In this case it is advantageous to also ascertain in some manner, e.g. by means of an acceleration sensor in the manner described above, the longitudinal position of the laser beam.

By the aid of position data collection, the 3D movement of the scanning apparatus 1 can be identified in relation to the structures being scanned, e.g. in relation to the inside walls of the elevator hoistway S, and the scanning data can later be corrected to correspond to reality in situations in which the movement of the scanning apparatus 1 has not been even during the scanning, e.g. if the elevator guide rails G along which the scanning apparatus is moved have twisted or turned. It is possible to collect position data in other ways than in the aforementioned ways.

The scanning apparatus 1 can be any scanning apparatus whatsoever, such as devices known in the art as a 3D scanning apparatus 1. The scanning apparatus 1 can comprise a plurality of receivers 3 moving as a single structure during the scanning, such as the receivers of a 3D scanner that are at a distance from each other, in which case the need for moving the scanning apparatus is less than with one receiver. FIG. 2 presents how, according to a preferred embodiment, a scanning device can, in principle, function, i.e. how the scanning apparatus 1 receives the data stream (e.g. an image or corresponding) relating to two structures from the same point of the structure from different directions with two receivers 3, such as with a camera or corresponding. For producing the correct type of image, the scanning apparatus can also comprise a projector or corresponding for transmitting e.g. the structured light of a transmitter to an object. Collecting data with a number of receivers (e.g. the receiving of images) from the same point of a structure simultaneously can form one of the aforementioned data collection phases. The use of a number of receivers 3 is preferred (but not necessary), so that the structures that are on the reverse side of the three-dimensional objects being scanned are photographed without requiring a large movement of the receiver 3. The receiver/receivers 3 preferably move in at least one direction, as is illustrated in the figures, but the receiver/receivers 3 can additionally, or alternatively, move in any other direction whatsoever, particularly if the aforementioned collection of position data is arranged. When a scanning apparatus 1 in which the scanning data to be received is based on the reflection from the structure being scanned of electromagnet radiation transmitted to the structure being scanned, it is advantageous that the transmitter also moves in a corresponding manner together with the scanning apparatus, thus forming a part of the movable scanning apparatus 1. The scanning apparatus can comprise a memory for recording scanning data and/or other data, such as position data, and a drive unit of the memory, such as e.g. a computer. Receivers 3 disposed in a corresponding manner to that presented in FIG. 2 can be on a number of sides of the scanning apparatus pointing in different directions, in which case the need for moving (e.g. rotating) the scanning apparatus diminishes.

Various scanning apparatuses 1 are known in the art, and they are commercially available. For example, a matrix camera/matrix cameras or a matrix camera/matrix cameras utilizing structured light, a matrix camera/matrix cameras utilizing a line laser, or a depth camera functioning on the Flight (ToF) principle, or a combination of the foregoing, can be suitable as a device for performing the scanning procedure of the scanning apparatus 1.

In the case of a matrix camera by the aid of video cameras or still photograph cameras a three-dimensional point model of the inside surface of an elevator structure being scanned, such as of the hoistway, is formed. In the case of one camera the system records a runtime image sequence, from which it is endeavored to distinguish features (points, edges, angles, textures, et cetera). The trajectory of the features appearing in different images is calculated in the image plane by correlating features between consecutive images. The trajectories formed by the features can after this be reconstructed into a three-dimensional point model. An acceleration sensor and other such sensor data can be used to support the reconstruction. The accuracy of the model depends on the camera used, the algorithm and the number of images taken. With this method on its own the scale cannot be calculated, but instead it must be estimated e.g. by means of known reference points. The method requires adequate lighting and that sufficient identifiable features are found from the inside surface of the elevator structure being scanned, such as of the hoistway. From the calculated point model a surface model can be formed later. The quality of the surface model in this case depends on the density of the point model. Also a number of matrix cameras can be used (stereo). In this case the cameras are calibrated beforehand and the pair features are calculated both from consecutive images and between camera pairs. By means of the method the scale can in this case also be calculated.

In the case of a matrix camera utilizing structured light, structured light refers to a light projector implemented with LED technology or projector technology, which forms a known light pattern on top of the object being photographed. The pattern is observed with a camera, and a point model or surface model of the object is calculated on the basis of the pattern. This is simple when the geometry (position and attitude) between the light source and the camera is known. By means of the method the scale can also be calculated, and it also functions on untextured surfaces. Depending on the calculation algorithm, the method produces either a point model or a surface model, and either one or a number of cameras can be used in it. The accuracy of the method depends on the number of images taken, the algorithm, the power of the light source, the shape of the pattern projected by it and the precision of the cameras used. An acceleration sensor and other such sensor data can also be used to support the reconstruction. In the method also a number of matrix cameras can be applied (stereo).

In the case of a matrix camera utilizing structured light, one or more cameras are applied as well as a line laser, the pattern formed by which on the surface of the elevator structure, such as a hoistway, being scanned is identified from the images. It is assumed that the geometry between the laser and the camera is known, in which case a surface model of the elevator structure being scanned can be calculated from the changes in the shapes of the line. The accuracy of the model depends on the camera used, the algorithm and the power of the line laser. An acceleration sensor and other such sensor data can also be used to support the reconstruction of a model.

In the case of scanning apparatus functioning on the Time-of-Flight (ToF) principle, a depth camera (3D camera) generates a depth map of the object being photographed, in addition to a conventional video image. For example, by combining depth maps photographed from the roof or the base of an elevator car, a surface model can be created from the travel. The accuracy of the model depends on the device used, the algorithm and the number of images taken. By means of the method also the scale, as well as the model, can be calculated, and it also functions on untextured surfaces. The method requires that the inside surface of a structure of the elevator, such as of a hoistway, does not absorb all the light into itself. An acceleration sensor and other such sensor data can also be used to support the reconstruction.

The above methods or the results given by them can also be combined with each other. It can, for example, be conceived that depth maps produced by a low-resolution ToF camera function as an initial conjecture for the reconstruction of photographs produced with a number of matrix cameras, in which case combining the image data is considerably facilitated.

The scanning data of the scanning apparatus 1 is preferably in the format of 3D coordinate measurements (e.g. x=length, y=width, z=height), in which case a number of coordinate points from the surface of the scanned structure have been recorded suitably densely in the scanning phase, based on the position of which coordinate points a three-dimensional model of the structure is formed. On the basis of the aforementioned position data, it is simple to correct the scanning data to correspond to reality taking into account the movement of the scanning apparatus during the scanning. After recording the scanning data, in the method a computer program is executed, which program forms a three-dimensional model on the basis of scanning data. A numerical model, for example, can be made from the scanning data, which model is transferred e.g. into a CAD design program for drawing the construction drawing.

The aforementioned three-dimensional model, which is formed with the method, can preferably be visually presented to the user by means of a computer (e.g. on a computer display). The aforementioned three-dimensional model can preferably be presented in this way with a CAD program, but other types of programs or presentation methods can produce the aforementioned advantages.

The structures being scanned can, at the moment of scanning, have been fabricated into their finished state or be semi-finished. In particular, if a need to modify a scanned structure is diagnosed on the basis of a three-dimensional model, the scanned structure can still be changed after the initial scanning. A scanned structure can also, at the time of scanning, have been fabricated into its finished state even if the elevator, of which the structure will form a part, is still being manufactured.

25

As stated above, it is advantageous to move the scanning apparatus during the scanning. The scanning apparatus 1 can be moved in many alternative ways. According to one embodiment the scanning apparatus 1 is moved in the space S of the elevator, when the space is an elevator hoistway S, along with the elevator car 2 or counterweight. If there is a need to perform scanning in a space in which there is no elevator car 2 or counterweight, or for other reasons it is not desired to utilize either of these, the moving of the scanning apparatus 1 can alternatively be otherwise implemented. For example, the scanning apparatus 1 can comprise means for laterally supporting the scanning apparatus 1 in the elevator hoistway S on a vertically extending continuous structure (e.g. on an elevator guide rail G) such as slide and/or roller guide shoes, for taking the lateral support force from the aforementioned vertically extending continuous structure. In this case the scanning device 1 can be moved closely along the aforementioned structure during the scanning, e.g. by pulling it up or lowering it down e.g. via a hoisting rope or corresponding. Alternatively, the scanning apparatus 1 itself can comprise means (such as a power device and power transmission and a traction means leaning on the aforementioned continuous structure) for moving the scanning apparatus 1 along the aforementioned vertically extending structure in the space S, M, I. If there is no aforementioned vertically extendable continuous structure in the space S, M, I, one such can be arranged in the space. It is also possible to move the scanning device 1 freely in the space S, M, I without supporting it in the lateral direction. This can be done e.g. by moving via the hoisting rope. On the other hand, the scanning arrangement 1 can comprise a base supporting it in its position and a lever system and/or telescopic boom system moving the scanning arrangement 1.

It is obvious to the person skilled in the art that in developing the technology the basic concept of the invention can be implemented in many different ways. The invention and the embodiments of it are not therefore limited to the examples described above, but instead they may be varied within the scope of the claims.

1. A method in the management of data relating to an elevator structure, wherein data is collected about the structures of the elevator, and the collected data is recorded in memory, said method comprising the steps of:
scanning the structures of an elevator with a scanning apparatus, which collects scanning data relating to the shape of the structures being scanned;
recording the scanning data in memory; and
forming a three-dimensional model of the structures of the elevator on the basis of the scanning data.

2. The method according to claim 1, wherein the structures of the elevator are scanned with a scanning apparatus at the elevator site.

3. The method according to claim 1, wherein the structures of an elevator are scanned with a scanning apparatus inside a space of the elevator.

4. The method according to claim 1, wherein the structures of an elevator are scanned with a scanning apparatus while moving the scanning apparatus during the scanning inside the space of the elevator, and the structures being scanned comprise the structures bounding the space and/or the structures that are inside the space.

5. The method according to claim 1, wherein the space is an elevator hoistway, a machine room or the interior of an elevator car.

6. The method according to claim 1, wherein in the step of scanning, the structures being scanned comprise the structures bounding a space of an elevator, including one or more of the following:
the wall(s) of the space:
the ceiling/roof of the space; and,
the floor of the space.

7. The method according to claim 1, wherein in the step of scanning, the structures being scanned comprise the edges of the opening/openings of floor landings.

8. The method according to claim 1, wherein in the step of scanning, the structures being scanned comprise the structures inside a space of an elevator, including one or more of the following:
a guide rail/guide rails of the elevator, such as the guide rail/guide rails of the elevator car and/or, counterweight;
the device(s) of the elevator that is/are inside the space, or parts of said devices, such as an overspeed governor, an elevator control unit, a hoisting machine or parts thereof; and
the rope(s) of the elevator that is/are inside the space.

9. The method according to claim 1, wherein in the step of scanning, a series of collection steps of scanning data to be linked to the shape of a structure being scanned is performed.

10. The method according to claim 1, wherein in the step of scanning, the position data of the scanning apparatus is collected, more particularly the position data of the receiver (3), comprised in the scanning apparatus and collecting the data.

11. The method according to claim 1, wherein in each collection step, collecting position data is connected to the collected data, which collecting position data comprises the prevailing position data of the scanning apparatus, and/or time data is connected to the data collected in each collection step, which time data indicates the collection moment of the scanning data.

12. The method according to claim 1, wherein the three-dimensional model is linked to form at least a part of the data that is in the database and is linked to the elevator-identification of the elevator, which database comprises a plurality of elevator-identifications and the data of an identified elevator connected to each elevator-identification.

13. Method The method according to claim 1, wherein in the method a computer program is executed, which program forms a three-dimensional model on the basis of scanning data.

14. The method according to claim 13, wherein the structures being scanned comprise the structures bounding a space of an elevator and/or the structures that are inside a space of an elevator, and after the formation of the aforementioned three-dimensional model, the elevator structures are installed into the space.

15. Method The method according to claim 13, wherein after the formation of the three-dimensional model a scanned structure of the elevator is modified.

16. The method according to claim 13, wherein after the formation of the three-dimensional model, a structure bounding the space of the elevator is modified.

17. The method according to claim 13, wherein after the formation of the aforementioned three-dimensional model, elevator structures are installed into the space, which structures comprise one or more of the following:
an elevator car:
the device(s) of the elevator, or parts of said devices, such as an overspeed governor, an elevator control unit, a hoisting machine or parts thereof;
a guide rail/guide rails of the elevator, such as the guide rail/guide rails of the elevator car and/or counterweight; and
the rope(s) of the elevator, such as suspension ropes.

18. The method according to claim 2, wherein the structures of an elevator are scanned with a scanning apparatus inside a space of the elevator.

19. The method according to claim 2, wherein the structures of an elevator are scanned with a scanning apparatus while moving the scanning apparatus during the scanning inside the space of the elevator, and the structures being scanned comprise the structures bounding the space and/or the structures that are inside the space.

20. The method according to claim 3, wherein the structures of an elevator are scanned with a scanning apparatus while moving the scanning apparatus during the scanning inside the space of the elevator, and the structures being scanned comprise the structures bounding the space and/or the structures that are inside the space.
